(19) United States
(12) Patent Application Publication
(10) Pub. No.: US 2002/0077828 A1
(43) Pub. Date: Jun. 20, 2002

(54) Distributed adaptive heuristic voice recognition technique

(75) Inventor: Max D. Robbins, New York, NY (US)

Correspondence Address: OSTROLENK FABER GERB & SOFFEN, 1180 AVENUE OF THE AMERICAS, NEW YORK, NY, 100368403

(73) Assignee: Building Better Interfaces, Inc.

(21) Appl. No.: 09/740,000

(22) Filed: Dec. 18, 2000

(51) Int. Cl. G10L 11/00

(52) U.S. Cl. 704/270.1

(57) ABSTRACT

A distributed adaptive heuristic voice recognition system which includes a server connected to a communications network, such as the Internet or some other global network, and a plurality of users who interact with the server over the communications network. The server is primarily responsive to two sets of data: a core speech recognition corpus (CORE) database, which is not user specific and a user specific individual profile (UIVP) database, which is user specific. The system uses the CORE database to develop the UIVP for an individual the first time the individual accesses the system, and then updates the individual's UIVP and the CORE database every time the system is used by such individual. The system, thus, constantly learns and adapts to user speech patterns, even if they change over time.

### BACKGROUND OF THE INVENTION

The present invention relates to voice recognition systems and, more particularly, to a distributed adaptive heuristic voice recognition system.

Current voice recognition technology is based on local storage of speech related data. Some systems are capable of learning in a heuristic fashion, as evidenced by products such as IBM's ViaVoice™ and Dragon Systems' Naturally Speaking™. The major problem with these systems is that in virtually all cases, once the training (learning) process is complete, the systems only provide marginal capability of 10 increasing their knowledge base. An additional issue with the existing technologies is that they are based on specific voice recognition algorithms. These constraints create a circumstance where the only possible growth of a system is severely limited.

### SUMMARY OF THE INVENTION

The foregoing problems are solved in accordance with the present invention by a distributed adaptive heuristic voice recognition system which includes a server connected to a communications network, such as the Internet or some other global network, and a plurality of users who interact with the server over the communications network. The server is primarily responsive to two sets of data: a core speech recognition corpus (CORE) database and a user specific individual profile (UIVP) database.

Because the voice recognition tasks can be handled by the server in the new system, and given the wide connectivity of the global network, the invention provides for continuous updating of individual voice profiles that is independent of location. The continuous process of uploading new voiceprint data each time the system is used and the downloading of this revised data to the client creates an environment where the overall system is constantly learning and adapting to the user speech patterns, even if they change over time.

Other features and advantages of the present invention will become apparent from the following description of the invention which refers to the accompanying drawings.

### BRIEF DESCRIPTION OF THE DRAWING(S)

FIG. 1 is a block diagram of a distributed adaptive heuristic voice recognition system in accordance with the present invention;

FIG. 2 is a block diagram of the functional elements of a processor forming part of the system of FIG. 1;

FIG. 3 is a block diagram showing operation of the system of FIG. 1 to identify a user; and

FIG. 4 is a block diagram of the system of FIG. 1 showing heuristic updating of the UIVP and CORE databases.

### DETAILED DESCRIPTION OF THE PREFERRED EMBODIMENT(S)

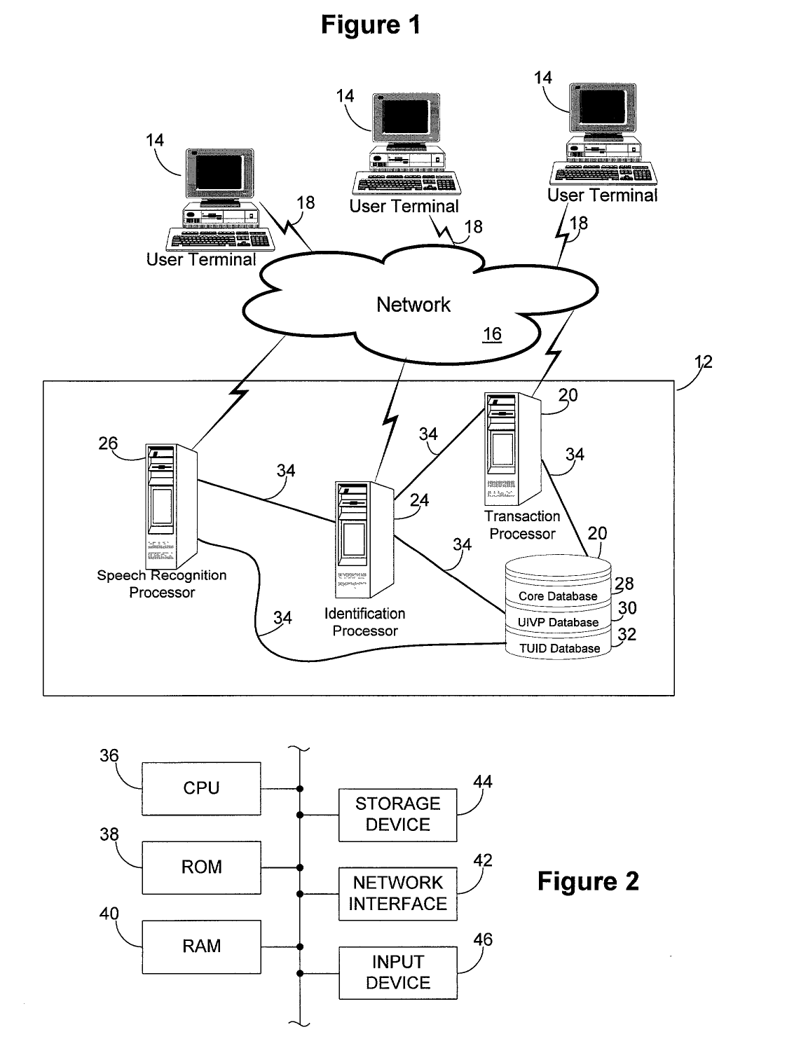

Referring now to FIG. 1, there is shown a diagram of a distributive adaptive heuristic voice recognition system 10 in accordance with the present invention.

The system 10 includes a server 12 and a plurality of user terminals 14 connected to a communications network 16 via communicating links 18. The communications network 16 can be any communication network but is preferably the Internet or some other global computer network. Communicating links 18 can be any known arrangement for accessing communication network 16, such as dial-up serial line interface protocol/point-to-point protocol (SLIP/PPP), integrated services digital network (ISDN), dedicated leased-line servers, broadband (cable) access, frame relay, digital subscriber line (DSL), asynchronous transfer mode (ATM), or other access technique.

User terminals 14 have the ability to send and receive voice data across communication network 16 using appropriate communication software, such as TCP/IP, POTS (Plane old telephone service), Frame Relay, ATM (Asynchronous Transfer Method), or any other transmission system capable of carrying speech data of a quality recognizable to a human. By way of example, terminals 14 may be a cell phone, a bank machine, automobile electronics, a Personal Data Assistant, a security device, or any electronic device that requires input from a human through any other medium such as keyboard, keypad, touch screen. As will be appreciated, the terminal 14 is fungible and can be traded for any system capable of digitizing and transmitting a voice sample.

The server 12 includes a plurality of constituent processors, such as a transaction processor 20, an identification processor 22 and a speech recognition processor 24. Additionally, the server 12 includes a data base 26, which includes a core speech recognition corpus (CORE) database 28, a specific individual voice profile (UIVP) database 30 for a plurality of individuals, and a specific terminal profile (TUID) database 32 for a plurality of terminals.

The CORE database 28 comprises a voice recognition database, such as SQL, Oracle, UDB, Flat File, Relational or other data structure capable of rapid storage and access of large mathematical data for recognizing non-individual specific speech. The UIVP database 30 is an individual specific database created from the interaction between the server 12 and specific individuals. The TUID database 32 is a recognition system database for specific terminals.

The databases 28, 30 and 32 can be integrated within the physical housing of one or more of the processors 20, 22 and 24, or can be a separate unit or units. If separate, the databases 28, 30 and 32 can communicate with the processors via connections 34 using any known communication method, including a direct serial or parallel interface or via a local or wide area network.

As shown in FIG. 2, the functional elements of each of the processors 20,24 and 26 preferably include a central processing unit (CPU) 36 used to execute software code in order to control the operation of the transaction processor, read-only memory (ROM) 38, random access memory (RAM) 40, at least one network interface 42 to transmit and receive data to and from other devices, and content across communication network 16, a storage device 44 such as a floppy disk drive, hard disk drive, tape drive, CD-ROM and the like for storing program code, databases and application data, and one or input devices 46 such as a keyboard and mouse.

The various components of the respective processors 20, 22 and 24 need not be physically contained within the same chassis or even located at a single location. For example, as explained above with respect to the databases 28, 30 and 32 (which can reside on one or more of the storage devices 44 of the processor 20, 22 and 41). The various components of the processors 20, 22 and 24 may be located at a site which is remote from the remaining elements of the processors, and may even, for example, be connected to respective CPU's 36 across communication network 16 via respective network interfaces 42.

Additionally, although the processors 20, 22 and 24 are shown as separate entities, two or more of them may be constituted by a single processor. Further, although only one of each of the processors 20, 22, 24 is shown for the sake of simplicity of explanation, it should be appreciated that a plurality of each may be provided.

The nature of the invention is such that one of ordinary skill in the art of writing computer executable code (software) will be able to implement the described functions using one or a combination of popular computing programming languages such as “C++,” Visual Basic, JAVA, HTML (hypertext markup language) or active-X controls and/or a web application development environment.

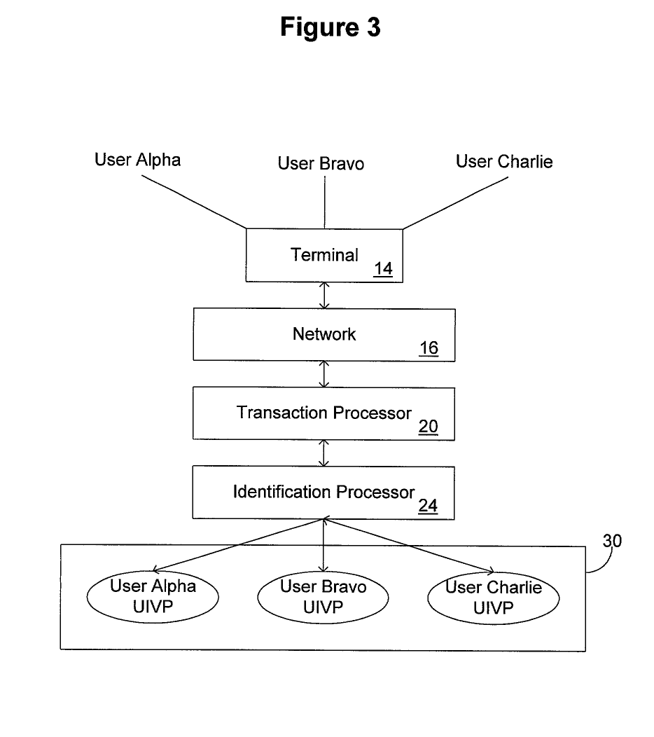

Referring now to FIG. 3, there is shown operation of the system in connection with user identification, in which a plurality of users designated Alpha, Bravo and Charlie interact with the system. Although the users Alpha, Bravo and Charlie are shown as interacting with the same terminal 14, as should be appreciated, each user can interact with the system via any terminal 14.

One of the users, such as the user Alpha, makes a voice request for a service or a transaction (e.g., a financial transaction such as withdrawal of cash from an account of user Alpha) to one of the terminals 14. Terminal 14 creates an identification request packet containing a sampling of voice from user Alpha with enough range to provide identification of user Alpha and forwards this data via the network 16 to the transaction processor 20. Enough range means that the sampling of data is long enough in terms of time and broad enough in terms of transmission of sounds (meaning the highs and lows within the range of human hearing have not been stripped off) to allow for a set of distinct vocal characteristics to be identified. These characteristics are then assigned mathematical values which form a signature or voiceprint. It should be noted that the characteristics are not what is said but distinct sounds characteristics caused by the shape of the mouth, throat, vocal chords, etc. Each person has a unique physiology that causes all of that person's speech to have an identifiable mappable set of prints regardless of what is said.

Transaction processor 20 notes the request from the terminal 14 and initiates a transaction tracking session for the length of the transaction (e.g., to establish a billing record). Transaction server also submits a recognition request packet with a transaction record appended to the identification processor 24. The transaction record is a number that tells the identification processor 24 what transaction this request belongs to. This allows the identification processor 24 to take numerous requests which may not be in order and return the information to the correct server and match it with the correct transaction. Such data tracking enables accurate tracking of transactions in a complex network with numerous simultaneous transactions occurring. The identification processor 24 takes the key elements of the voice sample (i.e., voiceprint), creates a search data set, compares against all users on file in the UIVP database 30 and searches for matches with user Alpha. If a match is found, the identification processor 24 then appends the UIVP to the identification request packet and returns the identification packet to the transaction processor 20. The transaction processor 20 then appends the UIVP information to the request packet and returns the packet to the terminal 14 used by user Alpha, which now has the requisite information to authorize transaction requests for user Alpha. If a match is not found, an error condition is generated and an alternative method of identification would be required, or a customer service incident is initiated.

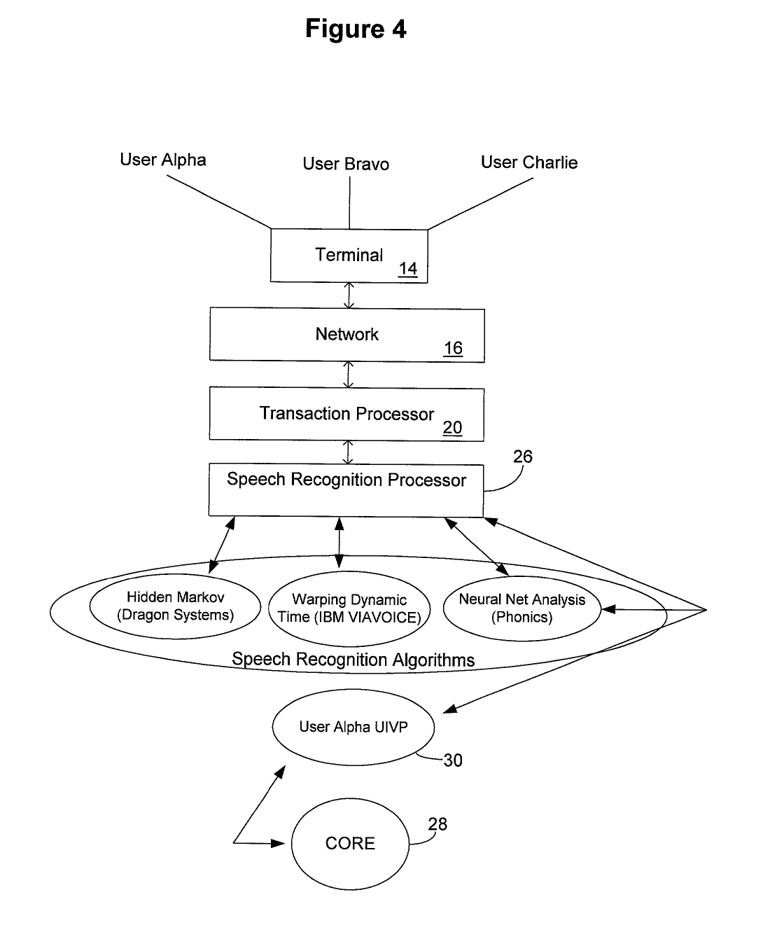

Referring now to FIG. 4, there is shown an operation of the system for heuristic update of the UIVP and CORE.

A terminal 14 after having initially identified a user as user Alpha, records or synthesizes all additional voice requests made by user Alpha. The terminal 14 depending on local storage capabilities can either store voice information locally for transmission over the network 16 off peak or provide real time synthesis and transmission. In either case the voice request is tagged as belonging to user Alpha with a corresponding UIVP. The terminal 14 sends complete voice recording via the network 16 to the speech recognition processor 26 via the transaction processor 2. As discussed above, the transaction processor 20 keeps all transaction related to the transaction being processed coordinated, as well as providing the record of the final transaction for billing or analysis purposes. The speech recognition processor 26 uses a heuristic method of analysis on the voice files to identify to the greatest degree of accuracy possible what was spoken and to identify any changes in the pattern of speech unique to user Alpha. To accomplish this, speech recognition processor 26 can utilize many different available commercial technologies for analysis. For example, the speech recognition processor 26 can utilize a hidden Markhov algorithm, such as the Dragon system, a warping dynamic time system algorithm, such as the IBM ViaVoice™ or a neural net analysis algorithm, such as the Phonics system. At any time during this process, the speech recognition processor can compare new data against the existing UIVP for user Alpha. Upon completion, the speech recognition server provides updated UIVP information that will accommodate natural changes in user Alpha's speech that have occurred over time thereby creating a more accurate, more recent UIVP.

Having now extensively analyzed a specific transaction set, the speech recognition processor 26 has the option of adding information to the CORE database 28, such as changes in the vernacular of the language or perhaps simply refining a specific global interpretation. The result of this system is that the UIVP for user Alpha is now more accurate and the CORE database 28 has an increased probability of correctly identifying a new user who either does not have a UIVP or has a small amount of reference data from which to aid in interpreting the correct recognition for a transaction.

As described, the system 10 follows the general client/server scheme, although it is possible to create stand-alone versions. The distribution of tasks between the client (i.e., the terminals 14) and the server 12 is variable, depending on specific system implementations. The system 10 acquires new voiceprint information every time the system 10 is used. This information is used to update the UIVP data in the UIVP database 30 for the individual while simultaneously performing the specific voice recognition and the subsequent transmission of data back to the client. The information is also used to update the CORE database 28.

One advantage of the subject invention is that it enables relatively simple devices to have sophisticated voice recognition capabilities. Current technology of voice recognition ultimately use comparisons against a database as its method of understanding. This is a slow iterative process which requires substantial computational power. The present invention centralizes (to a degree) the computation of the voice recognition data and removes the understanding function from the local client device. Thus a stereo system in the home or an automatic teller machine could implement a full voice interface by connecting to the system of the present invention.

It is important to note that the present invention is not a speech recognition algorithm, but rather a methodology of storing and rapidly accessing extremely specific information about an individual users voiceprint and having the system constantly learn from each interaction. As noted above, the system can be used with any speech recognition algorithm, such as long term feature averages, vector quantization, hidden Markhov models, neural networks and segregation techniques.

When a new user first approaches the system, the system must rely on the CORE database 26. The first use creates a UIVP (individual user profile). Each user of the system has their own unique UIVP. The UIVP is updated every time the user uses the system.

An important aspect is that the server 10 performs specific data manipulations on the data received from a specific transaction. The results of this data processing is used to update the UIVP database 28 and a new profile is downloaded to the client terminal 14 during the next transaction. An additional feature is that the server 12 uses this new information to make updates to the CORE database 30 when appropriate.

Having a server 12 (or a network of servers) also allows the establishment of a “Fee per Transaction” environment, which may be an incremental charge for each voice recognition transaction. Thus, the system 10 is capable of recognizing an individual no matter where the individual interconnects to the system and to accurately charge for the service provided.

Another aspect of this invention, employs “dumb speech recognition terminals” such as a automatic teller machine (ATM) or a personal music system. In the case of a cash machine, the machine would have a minimal capability consisting of a speech digitizing system integrated into it. There would be a unique profile created for this machine, the “TUID”, which TUID would be stored in the TUID database 30. This TUID would be similar to the UIVP in that it identifies a specific machine and its characteristics. When the ATM is used by an individual, the request is digitized and submitted to the server 12. The server 12 first uses the CORE database 28 to perform a basic interpretation of the data, then uses the UIVP database 30 to perform the exact recognition task and then transmit the information back to the client (in this case an ATM) over the network 16. The TUID provides the transaction processor 20 data on the terminal from which the request originated so that when a response is received either identifying the user or recognizing the speech that the appropriate result can be returned to the correct terminal. The TUID is basically a network address and is used to transmit results from any other system back to the initiating terminal. Because of the nature of the processing performed by the server 12, the actual amounts of data transmitted by the network 16 consist of small packets of information and are, therefore, not be unnecessarily burdensome to the network 16 in terms of bandwidth consumption.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for understanding an individual's voice, which comprises:
a) providing a voice recognition system which includes a first database of nonspecific voice recognition data and an individual specific database;
b) providing means for an individual to access the voice recognition system;
c) creating a specific individual voice profile for said individual using the first database;
d) storing said specific voice profile in the second database; and
e) revising said voice specific profile stored in said second database each time said individual accesses said system.

2. A method for understanding an individual's voice according to claim 1, wherein step b) comprises providing means for an individual to access a communications network and for the first and second databases to access the communications network.

3. A method for understanding an individual's voice according to claim 2, wherein the network is the Internet.

4. A method for understanding an individual's voice according to claim 1, further including a database of specific terminals and wherein step b) includes providing means for an individual to access one of said terminals.

5. A method of authorizing a transaction for an individual at a terminal comprising:
providing means at said terminal for said individual to request said transaction by a voice request;
communicating said voice request over a communications network to a voice recognition system for identifying the individual making the voice request; and
communicating the results of said voice recognition system to said terminal.

6. A method of authorizing a transaction for an individual at a terminal according to claim 5, wherein said communications network is the Internet.

7. A method of authorizing a transaction for an individual at a terminal according to claim 6, wherein the voice recognition system includes a first database of non-individual specific voice recognition data and a second database of individual specific voice recognition data and wherein step b) includes creating a specific individual voice profile for said individual using the first database, storing said specific voice profile in the second database and revising said voice specific profile stored in said second database each time said individual provides a transaction request to said voice recognition system.

8. A method of authorizing a transaction for an individual at a terminal according to claim 7, wherein step b) further includes searching said second database each time an individual requests a transaction to determine whether a voice profile of said individual matches a voice specific profile stored in said second database.

9. A method of authorizing a transaction for an individual at a terminal according to claim 7, wherein said system includes a third database of authorized terminals and said terminal is one of said authorized terminals.

10. A method of providing a voice recognition service, which comprises:
a) providing a voice recognition system;
b) enabling users to access this system over a communications network and provide requests for voice recognition data to said system;
c) processing the requests for voice recognition data to determine said voice recognition data; and
d) providing said voice recognition data to said user.

11. A method of providing a voice recognition system according to claim 10, wherein the communications network is the Internet.

12. A method of providing a voice recognition system according to claim 10, wherein the requests are voice requests.

13. A method of providing a voice recognition system according to claim 12, wherein the voice recognition system includes a first database of non-individual specific voice recognition data and a second database of individual specific voice profiles and wherein step c) includes creating individual specific voice profiles for said users using the first database, storing said specific voice profiles in the second database and revising said individual specific voice profiles stored in said second database each time a user provides a request for voice recognition data to said voice recognition system.

14. A method of providing a voice recognition service according to claim 13, wherein step c) further include s searching said second database each time a request is received from a user to determine whether a voice profile of said user matches a voice specific profile stored in said second database.

15. A voice recognition system repetitively accessible by an individual, which comprises:
a first database of non-specific voice recognition data;
a second database of individual specific voice recognition data;
means for receiving voice data of an individual;
means for creating a specific individual voice profile for said individual based on said received voice data using the first database;
means for storing said specific voice profile in the second database; and
means for revising said voice specific profile stored in said second database each time said individual accesses said system.

16. A voice recognition system according to claim 15, wherein the means for receiving includes means for interacting with a communications network.

17. A voice recognition system according to claim 16, wherein the communications network is the Internet.

18. A voice recognition system which comprises:
a first database of non-specific voice recognition data;
a second database of individual specific voice recognition data;
a speech recognition processor for interacting with the first and second databases;
a transaction processor for receiving a voice recognition request from a user; and
an identification processor for receiving the voice recognition request from said transaction processor, said voice recognition request including voice data of said user and said identification processor comparing said voice data against the individual specific voice data in the second database and, if a match is found, returning the identified user information to the transaction processor and, if a match is not found, providing a request to said speech recognition processor to search the first database to create voice recognition data for said user.

19. A voice recognition system, which comprises:
a first database of non-specific voice recognition data;
a second database of individual specific voice recognition profiles;
means for receiving voice data of an individual from a communications network;
search means for searching the second database to determine whether there is a match between the voice data of said individual and a voice profile stored in said second database; and
means for creating a specific individual voice profile for said individual based on said received voice data using the first database if a match is not found by said search means.

20. A voice recognition system according to claim 19, further including means for revising said voice specific profile stored in said second database each time said individual accesses said system.

21. A voice recognition system according to claim 19, wherein the communications network is the Internet.
